(19) United States
(12) Patent Application Publication
(10) Pub. No.: US 2006/0185167 A1
(43) Pub. Date: Aug. 24, 2006

(54) Mechanical method for joining of tubular member to a plate member

(76) Inventors: Michael R. Lippa JR., Amherst, NY (US); Kenneth A. Verhage, East Amherst, NY (US); Kristen Ann Gerstung, Sanborn, NY (US); Lori H. Runk, North Tonawanda, NY (US); William James Kumpf, Lockport, NY (US)

Correspondence Address: PATRICK M. GRIFFIN;DELPHI TECHNOLOGIES, INC., Legal Staff, Mail Code 480-410-202, P.O. Box 5052, Troy, MI, 48007-5052, US

(21) Appl. No.: 11/064,377

(22) Filed: Feb. 23, 2005

(51) Int. Cl. B23P 15/26; B23P 11/00

(52) U.S. Cl. 29/890.038; 29/890.043; 29/509; 29/510; 29/511; 29/512

(57) ABSTRACT

A method for joining an inlet/outlet pipe to a heat exchanger core in which a standard coupler of stepped cylindrical shape is first brazed integrally to the core. A unique pipe is then attached inside the outer end of the coupler purely mechanically, with a compression ring that is forced axially over the outside of the coupler to compress the inner surface of the coupler against the outer surface of the pipe. The axial force is applied between the ring and an integral bead on the coupler, so as to protect the coupler braze joint from damage.

### TECHNICAL FIELD

This invention relates to a purely mechanical, no-weld method for joining a tubular member of varying size or shape to a plate member, such as an inlet/outlet pipe joined to a tank surface of a heat exchanger.

### BACKGROUND OF THE INVENTION

Heat exchanger cores, such as automotive air conditioning system condensers typically have a standard frontal area and depth, but are installed in a wide variety of vehicle models, with varying locations of fluid or refrigerant lines and hoses. This requires that the inlet/outlet pipes of the core, which will ultimately be connected to the lines and hoses, be varied in length and shape (diameters are generally fairly standard). The jigs and clamps used in the core braze process are designed to accommodate the standard tubes, tanks and fins of the standard core. It is difficult, generally impractical, to modify the braze process and apparatus to allow the integral attachment of inlet/outlet pipes of varying length and shape, especially when they are very long or bent into particularly convoluted shapes. Proposals exist for doing so, see, for example, co assigned U.S. Pat. No. 5,680,897. Typically, however, unique pipes have been added to a standard size core by a post braze, manual welding process, which obviously adds expense and processing time.

### SUMMARY OF THE INVENTION

In the subject invention, a novel, purely mechanical method is provided for attaching a customized inlet/outlet pipe to the standard brazed core. In the core braze process, a standard, short coupler is brazed to the manifold tank or tanks at any location where an inlet/outlet pipe will be needed. The standard coupler is a stamped aluminum piece of two sided braze clad stock, with a stepped cylindrical shape. A cylindrical plug at the inner end is inserted closely through a hole in an outer surface (generally a flat side plate) of the tank until a larger diameter shoulder engages the outer surface. The bottom edge of the plug end is then flared outwardly to trap the coupler in the hole. The coupler also includes a radially outwardly extending integral bead, slightly axially spaced from the shoulder of the plug end, and a pipe receiving outer end within which the end of the pipe to be attached will ultimately be received.

After the plug end of the coupler is trapped and flared into the hole in the core manifold tank, the core is brazed, creating a solid, leak proof braze joint between the coupler and the tank. This joint is vulnerable to stress damage, however, during the process of attaching the inlet/outlet pipe. After the core braze is complete, a compression ring with an inner diameter sufficiently small to make a tight, non-damaging compressive fit over the outer surface of the coupler's pipe receiving end is placed over the end of the inlet/outlet pipe, before it is inserted into the coupler. Next, a suitable tool is hooked behind the coupler bead, and an axial pressing force is applied by the tool, reacting off of the bead, to push the compression ring firmly over the outer surface of the coupler's pipe receiving end. The ring compresses the outer end of the coupler radially inwardly sufficiently to create a leak proof joint between the inner surface of the coupler and the outer surface the pipe, without crushing or deforming either. The ring application force is isolated from the coupler-to-core braze joint by virtue of being able to react off of the integral bead, protecting the braze joint from damage. Therefore, a unique pipe of any length or shape can be added to the standard core and coupler, without welding.

### BRIEF DESCRIPTION OF THE DRAWINGS

FIG. 1 is a cross section of a hole in a plane surface of a core tank, with the unattached coupler aligned therewith;

FIG. 2 shows the plug end of the coupler inserted in the hole and in the process of being flared into place, pre braze;

FIG. 3 shows the coupler in the process of being brazed into the core;

FIG. 4 shows the inlet/outlet pipe with a compression ring inserted loosely over the outside thereof, being moved toward insertion into the coupler,

FIG. 5 shows the ring pressing tool hooked behind the coupler bead and pushing the ring in place over the outside of the end of the coupler;

FIG. 6 shows the compression ring pushed fully in place.

### DESCRIPTION OF THE PREFERRED EMBODIMENT

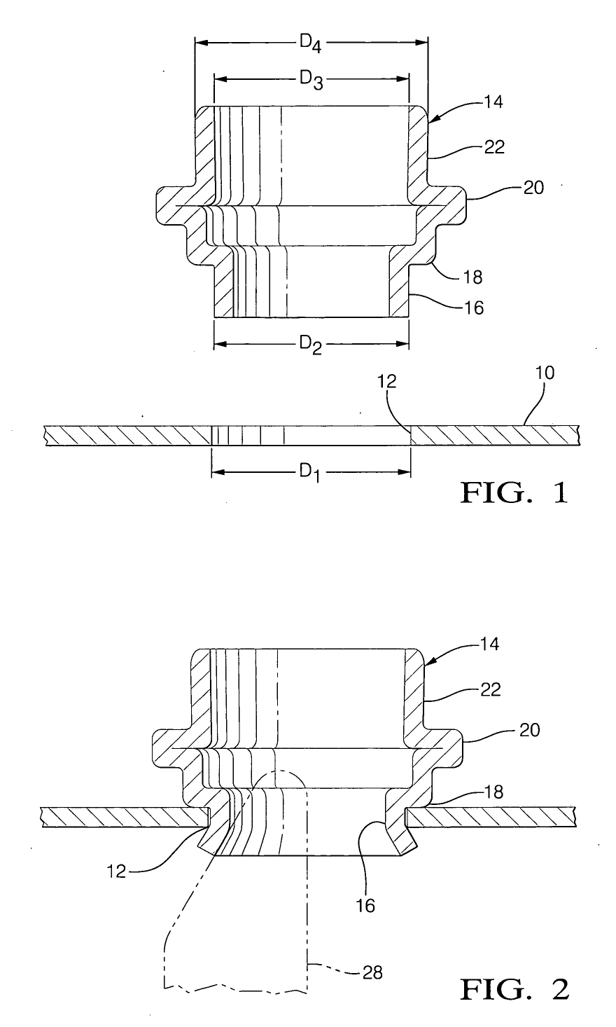

Referring first to FIG. 1, a plate like, planar portion of a heat exchanger core 10 (typically the flat so called “side plate” of a manifold tank) has a round hole 12 of diameter D1 cut through it, in a location where it will ultimately be desired to attach an inlet/outlet pipe. Conventionally, that pipe would simply be manually welded into hole 12 in a separate, post braze operation, which adds time, cost, and potential inconsistency to the process. Instead, in the process disclosed by the subject invention, a standard inlet/outlet pipe coupler, indicated generally at 14, is attached to and through the hole 12 first, as part of the core braze process, and then an inlet/outlet pipe is installed in coupler 14, post braze, by a consistent, simple, and weld free process. Coupler 14 is stamped from 1 mm thick aluminum stock, braze clad on two sides by a suitable braze material, such as an aluminum-silicon alloy that melts at a braze temperature lower than the melting temperature of the base alloy, and which is drawn by capillary action into any available surface to surface interfaces or close clearances during the braze process. Coupler 14 is stamped by a conventional transfer die and press apparatus. The shape is generally a stepped cylinder, with several different inner diameters and structural features designed to cooperate both with the hole 12, the inlet/outlet pipe, and an installation tool described later. An innermost, plug end 16 has an outer diameter D2 substantially equal to the diameter D1 of hole 12, but with enough radial clearance, about 0.5 mm, to allow easy insertion while leaving an annular space into which melted braze material can be drawn. An integral, right angle shoulder 18, approximately a millimeter larger in diameter than hole 12, acts as a stop when plug end 16 is inserted. The shoulder portion 18 ends in an integral, double fold bead 20, which has closely engaged inner surfaces and which extends radially outwardly a couple of millimeters of shoulder 18. A pipe receiving outer end 22 has an inner diameter D3, and an outer diameter D4 larger by twice the stock thickness. Pipe receiving outer end 22 may be slightly rounded of on its terminal edge, if desired.

Referring next to FIG. 4, the end of a pipe 24 that will ultimately be installed in coupler 14 is illustrated. It, too, will most likely be aluminum, though it can be unclad, as it will not be brazed to any other part. It's outer diameter D5 is designed to be less that that of the coupler pipe receiving end inner diameter D3, by approximately 0.1 mm, with just sufficient radial clearance, and no more, to allow for an easy slip fit. The end of pipe 24 would be carefully resized and “re rounded” both to assure and maintain that diameter difference, and to provide a surface suitable to the sealing interface that is created later. A compression ring 26, made of a high strength aluminum, has a generally annular shape, with an inner diameter D6 designed to be approximately 0.26 mm smaller than the outer diameter D4 of the coupler outer end 22. Ring 26 has a thickness of a few millimeters, substantially thicker and stronger than the material of either coupler 14 or pipe 24, and is slightly rounded on both of its inner edges, so as to be axially symmetrical. Ring is not, and need not be, braze clad, but it is desirable that all three components, coupler 14, pipe 24, and ring 26, be of similar metals, for galvanic and thermal expansion compatibility. The same applies to the main surface 10.

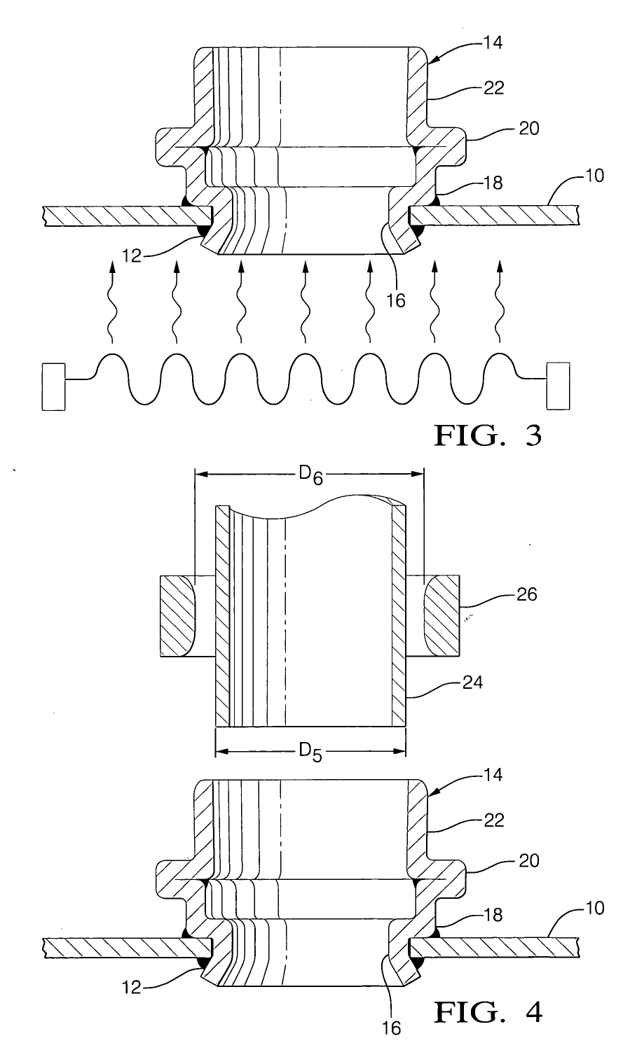

Referring next to FIGS. 2 and 3, the first step in the process (after the manufacture of the components just described) is to insert the coupler plug end 16 into hole 12, and to flare out its inner end, by a suitable tool 28, to trap the edge of hole 12 closely and firmly between shoulder 18 and the flared edge of plug end 16. In many cases, access will be available for a tool both from above and below hole 12. If access is from one side only, the edge of plug end 14 could still be spun out sufficiently to grab the edge of hole 12. This edge trapping need does not provide a seal, but holds the coupler 14 firmly in place during the core braze process, when melted braze material from the outer surface of coupler 14 is pulled into the annular gap with the edge of hole 12, and later solidifies (FIG. 3). Braze material from the inner surface is also pulled into the interface between the inner surfaces of the double fold bead 20, solidifying to create a strong, double thickness, integral structure. The braze seam so formed around the plug end 16 is leak proof, but is not designed to take a great deal of strain or resist significant axial or twisting forces. The brazing process also serves to effectively anneal the material of coupler 14 so that it is not brittle, which aids in the further processing described below.

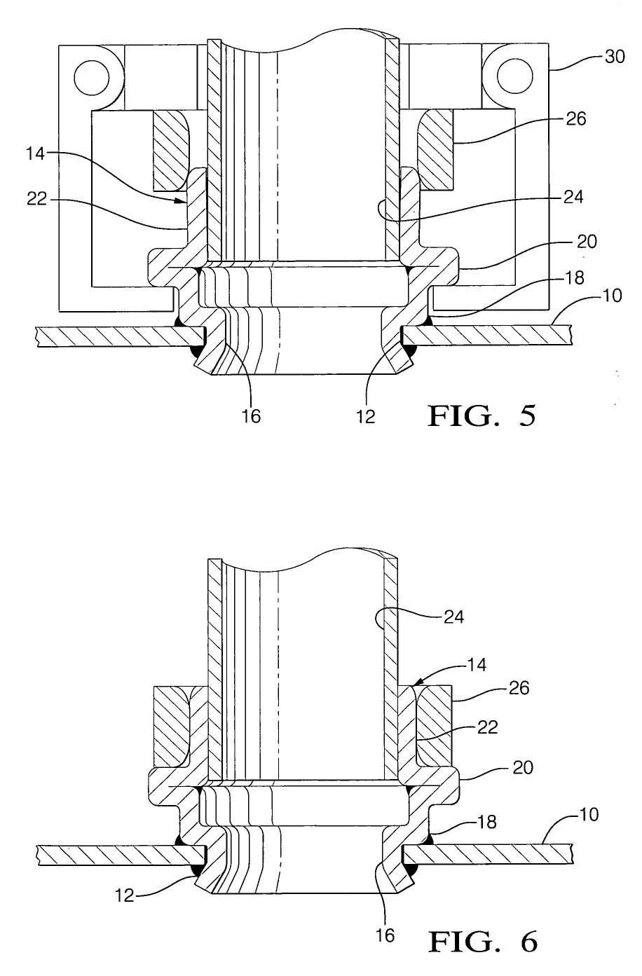

Referring next to FIGS. 4 and 5, after the brazing of coupler 14 has been completed, a compression ring 26 is placed over the end of pipe 24, which is then inserted into the coupler outer end 22, at least deep enough to overlap most of the axial length of coupler outer end 22. Next, a suitable tool 30 is hooked over and behind the bead 20, as well as behind the edge of ring 26, which is then pressed axially down over the outside of the coupler outer end 22. The axially symmetrical shape of ring 26 obviates any need to orient it before it is pushed. The outside of bead 20 provides a positive stop, if needed. Because of the D6-D4 interference noted above, a strong, radially inwardly acting and continuous compressive force acts to slightly, and evenly, compress the inner surface of coupler outer end 22 into and against the outer surface of pipe 24, but the interference is not sufficient to crush, crack wrinkle or otherwise deform either part. This creates a solid, leak proof interface, without welding, adhesive or additional O rings. The ability of tool 30 to react off of the strong, two layer, integral bead 20 isolates the braze seam between the coupler 14 and the edge of hole 12 from any twisting or bending forces from tool 30. Therefore, a pipe 24 unique to any heat exchanger application can be attached to the otherwise standard coupler 14, purely mechanically, and without subsequent welding or brazing.

Variations in the disclosed method could be made. The coupler plug end 16 could be temporarily retained, pre braze, by any suitable means that would hold it within hole 12 with sufficient stability to not shift during the brazing process. A very tight press fit would be undesirable, however, as that would not allow for the all round annular clearance needed to create a good braze pocket. The bead 20 could theoretically be formed other than as a double fold, for example, as an outward bulge. Or, the bead could be formed as an integral fold, but in a three layer, Z shape, or a four layer configuration, for additional strength, if desired. As disclosed, the inner diameter of the coupler's plug end 16 is smaller than the outer diameter D5 of the pipe 24. Consequently, the inner surface of plug end 16 acts as a stop to prevent the end of pipe 24 from being over inserted into coupler 14. That is not necessary, but an advantage that flows from the fact that D1 is comparable to D5. However, D1 could be sufficiently larger than D5 that the end of pipe 24 would easily pass through the inner surface of the coupler plug end 16, without affecting the basic operation of the invention.

1. A method of joining a cylindrical inlet/outlet pipe with a pre determined outer diameter to a circular hole in a brazed metal heat exchanger surface, comprising the steps of,
forming a standard coupler from brazeable stock metal having an inner, cylindrical plug end with an outer diameter slightly smaller than the diameter of said circular hole and adjacent to an integral, radially outwardly extending shoulder, a cylindrical outer pipe receiving end having an inner diameter slightly greater than the outer diameter of said inlet/outlet pipe, and an integral, radially outwardly extending bead intermediate said pipe receiving outer end and said shoulder, and axially spaced from said shoulder,
providing an annular compression ring having an inner diameter slightly smaller than the outer diameter of said coupler pipe receiving end,
temporarily retaining said coupler plug end through said circular hole,
brazing said coupler plug end into said circular hole during the core brazing process to create a leak proof braze seam between said coupler plug end and said circular hole,
fitting said compression ring loosely over said pipe and inserting the end of said pipe into said coupler pipe receiving end,
applying an axial force between said coupler bead and said compression ring sufficient to axially force said compression ring over the outer surface of said coupler pipe receiving end, thereby compressing the inner surface of said coupler outer end into and against the outer surface of said pipe sufficiently to create a leak proof seal between the two, while isolating the axial force of installing said compression ring from said braze seam.

2. The method as described in claim 2, further characterized in that brazeable metal stock is clad on both the inner and outer surface with braze material, and the bead is formed as a double fold.

3. The method as described in claim 3, further characterized in that the axial force is applied by a tool engaged between the back of the bead and the back of the compression ring.

4. The method as described in claim 3, further characterized in that the compression ring is axially symmetrical.
